(19) United States
(12) Patent Application Publication
(10) Pub. No.: US 2014/0040068 A1
(43) Pub. Date: Feb. 6, 2014

(54) Service Recommender System For Mobile Users

(71) Applicants: Saravanan Mohan, Chennai (IN); Sriram Ravi, Chennai (IN); Niranjan Santhalingam, Chennai (IN); Aashan Ram Sayeeram, Chennai (IN)

(72) Inventors: Saravanan Mohan, Chennai (IN); Sriram Ravi, Chennai (IN); Niranjan Santhalingam, Chennai (IN); Aashan Ram Sayeeram, Chennai (IN)

(21) Appl. No.: 14/111,858

(22) PCT Filed: Nov. 23, 2011
(86) PCT No.: PCT/SE2011/051411

§ 371 Date: Oct. 15, 2013

(30) Foreign Application Priority Data
Apr. 15, 2011 (IN) 1122/DEL/2011

(51) Int. Cl. G06Q 30/06

(52) U.S. Cl. CPC G06Q 30/0631
USPC 705/26.7

(57) ABSTRACT

A mobile recommendation system for providing one or more recommendations to a group of mobile users having specific behavior characteristics among a plurality of mobile users is disclosed. The mobile recommendation system comprises of a pre-clustered repository that is configured to store pre-cluster data of the group of mobile users. The mobile recommendation system further comprises a processor capable of controlling a mobile identification generation module that is configured to create a plurality of pre-clusters of mobile users with regard to the pre-cluster data stored in the pre-clustered repository and to generate a unique identification parameter for each mobile user for identifying a priority of the specific behavior characteristics of the respective mobile user in the respective precluster. The processor is also capable of controlling a categorizing module that is configured to identify the group of mobile user with respect to the specific behavior characteristics of each mobile user and categorize one or more mobile users as influential users among the selected group of mobile users based on the unique identification parameter, and identifying at least one recommendation for the selected influential users. The mobile recommendation system further comprises a mobile interface that is configured to communicate one or more recommendations to each influential mobile user.

### TECHNICAL FIELD

The present invention relates to a unique identification parameter for identifying specific behavior characteristics of a mobile user among a plurality of mobile users. More particularly, the present invention relates to methods, system and a computer program product for providing recommendations to the mobile users based on the unique identification parameter in a communication network.

### BACKGROUND

Nowadays, mobile advertising is constantly increasing with the increase in usage of mobile devices. Advertisement information may be provided via a system in a cellular communication network. Such systems typically recommend products and services to mobile users based on a plurality of properties such as e.g. location, likes, etc. These systems provide personalized and more focused content to the mobile user, hence limiting the negative effects of information overload.

Existing systems that are currently available to provide advertising information are generally location and time based systems. Location based systems deal with grouping all mobile users that are present in a particular location. The characteristics of such groups do not involve likes and dislikes of the present mobile users. It is mostly centered on the location and thus may not pertain to the likes and dislikes of the mobile users. The location of a user is noted for a predetermined time period and the location, in which the mobile user spends most of his time, is determined. The mobile user would be placed into a location group corresponding to the determined location and provided recommendations accordingly. Time based systems involve grouping of mobile users into time slots. For instance, the most commonly considered time slots are 9 am-5 pm, 5 pm-1 am, and 1 am-9 am. Based on the frequency of calls made by a user in these particular time slots, the user would be included into the group related to a particular time slot. Hence, the service provided does not correlate to the mobile user's need and may infact lead to dissatisfaction of the mobile users and may also prove to be a loss to the service provider.

Systems operating according to any of the strategies mentioned above generally use static grouping approaches and processing is performed only on static data. Static grouping involves the use of predefining groups of users with relevant values and properties. The static data refers to data that is readily available at the time of processing without any further modifications. Though this data needs lesser processing time and requires less processing capabilities, it cannot be incorporated into the situation where the operator needs to take a faster decision on launching recommendations. The reason is that the mobile user would be considered for recommendation only when the user enters a particular location, typically within a few allotted minutes. If the mobile user is not available at the location, then the mobile user's data that is statically available will be of no use, thereby occupying unwanted memory space in a database.

In addition, the existing systems or the service provider that provide services to the mobile users often knows the interest of a mobile user beforehand. The service provider may hold a poll or feedback session where the mobile user informs the service provider of their availability at the location. Yet another approach is to have static data available at hand at the location. Static data refers to the entire mobile user database that holds information such as e.g. usage, money spent, call duration, location, etc. The database is mined for requisite information and then, based on the results, recommendations are provided. Such approaches are normally not personalized and a recommendation that does not suit the mobile user's need may be provided, very likely resulting in an unsatisfied mobile user.

In both the above-mentioned systems, a lot of time is used for processing and generating results. Another important factor is the extensive memory that has to be used to store the static information required for data mining. In addition, the processing hardware and other system requirements are very high. Consequently, a recommendation may not be provided in time.

Hence, there is a need for overcoming at least one of the above-mentioned shortcomings and providing an improved mobile recommending system and methods thereof.

### SUMMARY

It is an object of the present invention to dynamically identify specific behavior characteristic of mobile users in a communication network.

It is yet another object of the present invention to provide a recommendation to one or more mobile users based on respective specific behavior characteristic at a given time and location.

A mobile recommendation system for providing one or more recommendations to a group of mobile users having specific behavior characteristics among a plurality of mobile users is disclosed. The mobile recommendation system comprises a pre-clustered repository that is configured to store pre-cluster data of the group of mobile users. The mobile recommendation system further comprises a processor having a mobile identification generation module that is configured to create a plurality of pre-clusters of mobile users with regard to the pre-cluster data stored in the pre-clustered repository and to generate a unique identification parameter for each mobile user for identifying a priority of the specific behavior characteristics of the respective mobile user in the respective pre-cluster. The processor further having a categorizing module that is configured to identify the group of mobile users with respect to the specific behavior characteristics of each mobile user and to categorize one or more mobile users as influential users among the selected group of mobile users based on the unique identification parameter, and identifying at least one recommendation for the selected influential users. The mobile recommendation system further comprises a mobile interface that is configured to communicate one or more recommendations to each influential mobile user.

A method of providing a unique identification parameter to each of a plurality of mobile users to identify specific behavior characteristic of the mobile users is also disclosed. The method comprises the steps of creating a plurality of pre-clusters wherein each pre-cluster have a pre-defined group of the mobile users and generating a unique identification parameter for each mobile user. The unique identification parameter comprises a static component and a dynamic component, the static component comprises a mobile user identification and a pre-cluster identification and the dynamic component comprises a priority identification of the mobile user for a specific behavior characteristics in the respective pre-cluster. The method further comprises associating each unique identification parameter with the respective mobile user such that the dynamic component of the unique identification parameter automatically updates the priority identification with respect to the specific behavior characteristics of the respective mobile user.

A method of providing one or more recommendations to a group of mobile users present at an event having specific behavior characteristics among a plurality of mobile users is also disclosed. The method comprises the steps of creating a plurality of pre-clusters, wherein each pre-cluster have a pre-defined group of mobile users and generating a unique identification parameter for each mobile user for identifying a priority of specific behavior characteristics of the mobile user in the respective pre-cluster. The method further comprises selecting a group of mobile users available at the event and categorizing a mobile user from the selected group of mobile users as an influential or non-influential user based on the identified specific behavior characteristics of the mobile users. The method further comprises providing the recommendations to each influential user among the plurality of mobile users available at the event.

A unique identification parameter for identifying a specific behavior characteristic of a mobile user among a plurality of mobile users is also disclosed. The unique identification parameter comprises a static component having a mobile user identification and a pre-cluster identification wherein each pre-cluster have a pre-defined group of mobile users. The unique identification parameter further comprises a dynamic component having a priority identification of the mobile user wherein the dynamic component automatically updates the priority identification with respect to the specific behavior characteristics of the respective mobile user in the pre-cluster.

A computer program for providing recommendations to a group of mobile users having specific behavior characteristics among a plurality of mobile users is also disclosed. The computer program comprises code means which when run on a mobile recommendation system causes the mobile recommendation system to create a plurality of pre-clusters, wherein each pre-cluster have a pre-defined group of mobile users and generate a unique identification parameter for each mobile user for identifying a priority of the specific behavior characteristics of the respective mobile user in the respective pre-cluster. The code means further causes the mobile recommendation system to select a group of mobile users available at the event and categorize a mobile user belonging to the selected group of mobile users as an influential or a non-influential user based on the identified specific behavior characteristic of the mobile user. The code means further causes the mobile recommendation system to provide at least one recommendation to each influential user among the plurality of mobile users available at the event.

### BRIEF DESCRIPTION OF THE DRAWINGS

To further clarify the above and other advantages and features of the disclosure, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail with the accompanying drawings in which:

FIG. 1 illustrates a schematic diagram of a mobile recommendation system in accordance with an embodiment of the invention;

FIG. 2 illustrates a flow chart showing a method of providing recommendations to one or more mobile user in accordance with a first embodiment of the invention;

FIG. 3 illustrates a flow chart showing a method of providing recommendations to one or more mobile user in accordance with a second embodiment of the invention;

FIG. 4 illustrates a schematic diagram showing an example of pre-clustered data in accordance with an embodiment of the invention;

FIG. 5 illustrates a unique identification parameter in accordance with an embodiment of the invention;

FIG. 6 illustrates a specific example of grouping the mobile users with common behavior into one dynamic cluster in accordance with an embodiment of the invention;

FIG. 7 illustrates a specific example of further grouping the mobile users with common behavior within the dynamic cluster in accordance with an embodiment of the invention;

FIG. 8 illustrates a flow chart for grouping the mobile users into dynamic clusters in accordance with an embodiment of the invention;

FIG. 9 illustrates a schematic diagram showing a computer program product in accordance with an embodiment of the invention;

FIG. 10 illustrates a flow chart showing a method of providing recommendations to influential users in accordance with an embodiment of the invention.

### DETAILED DESCRIPTION

Embodiments of the invention discloses a unique identification parameter for identifying a specific behavior characteristic of a mobile user among a plurality of mobile users and methods, system and a computer program product for providing recommendations to the mobile users based on the unique identification parameter in a communication network.

According to an embodiment of the invention, a plurality of pre-clusters are created, wherein each pre-cluster have a pre-defined group of mobile users such as a community or an office or a locality, etc. For each mobile user in each group, a unique identification parameter, such as a unique number is generated. The unique identification parameter is configured to identify a priority of specific behavior characteristics of the mobile user in the respective pre-cluster. On identification, the specific behavior characteristics of each mobile user is stored in a pre-clustered repository and is updated thereon over a period of time on the basis of pre-determined characteristics such as number of services used, amount spent for services, etc. The stored information may then be used to selectively provide recommendations to the mobile user specifically when a large number of mobile users are available at an event. Based on the availability of mobile users at the event, their respective preferences and the specific behavior characteristic, the recommendations are provided.

According to another embodiment of the invention, the specific behavior characteristics of a mobile user may be the usage of pre-determined services by the mobile user. The usage of pre-determined services here is considered as determining the willingness of the mobile user to be interested in the same or similar pre-determined services.

An event is to be referred to as a common place or any public location that witnesses the presence of a large number of mobile users, and may include e.g. stadiums and/or public meetings, etc.

According to another embodiment of the invention, the system is configured to provide service type recommendations to a plurality of mobile users. The service recommendations may include services pertaining to likes/dislikes and preferences of the mobile users. These service recommendations may be in the form of an advertisement, a banner, a web link, or any other form of service recommendation known in the art.

According to another embodiment of the invention, the unique identification parameter may be an identification of the mobile user, comprising information relating to a pre-cluster to which the mobile user belong and a priority rank of the mobile user within the pre-cluster, and an associated pre-cluster ID.

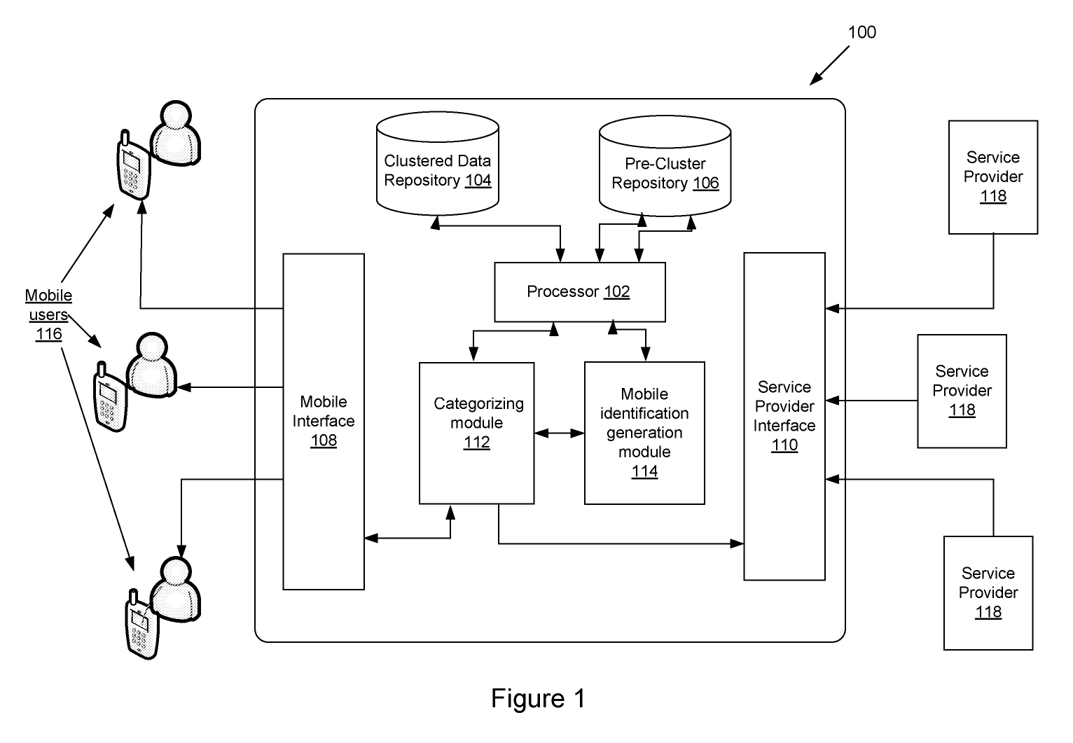

FIG. 1 illustrates a mobile recommendation system in accordance with an embodiment of the invention. The mobile recommendation system 100 comprise a processor 102, such as a DSP (Digital Signal Processor) or CPU (Central Processing Unit). The processor 102 is connected to a pre-clustered repository 106 and a clustered data repository 104. The mobile recommendation system 100 is accessible by a plurality of mobile users 116 and service providers 118 via a mobile interface 108 and service provider interface 110, respectively. For implementation purposes any of a hard disk, a magnetic tape, a remote backup service or any other large backup device may be used as a pre-clustered repository 106 and a clustered data repository 104, respectively.

The processor 102 is a device responsible for targeting one or more recommendations to a plurality of mobile users 116 by controlling one or more modules, here represented by a mobile identification generation module 112 and a categorizing module 114.

The mobile identification generation module 114 is configured to create a plurality of pre-clusters of mobile users with regard to the pre-cluster data stored in the pre-clustered repository 106. The mobile identification generation module 114 is further configured to generate a unique identification parameter for each mobile user for identifying a priority of the specific behavior characteristic of the mobile user in each pre-cluster.

The categorizing module 112 is configured to identify a group of mobile users with respect to the specific behavior characteristic of the mobile users. The categorizing module 112 is further configured to categorize a plurality of mobile users as influential or non-influential users among the selected group of mobile users based on the unique identification parameter, and identify at least one recommendation for the selected influential users.

The mobile interface 108 is configured to directly communicate with a plurality of mobile communication devices of the respective mobile users 116. The mobile interface 108 is configured to send one or more recommendations to the mobile users 116.

The service provider interface 110 is configured to directly communicate with at least one service provider 118. The service provider interface 110 is configured to receive information about services being offered by the service providers 118.

According to an embodiment of the invention, the pre-cluster repository 106 is configured to have a pre-emptive knowledge of the mobile users stored in the form of useful attributes. The clustered data repository 104 contains a plurality of dynamic clusters containing user's interest and prioritized ranking performed for the selective recommendations. In one aspect of the invention, the details of customer behavior are optimized to form pre-clusters and the details are then dynamically processed for selective recommendations.

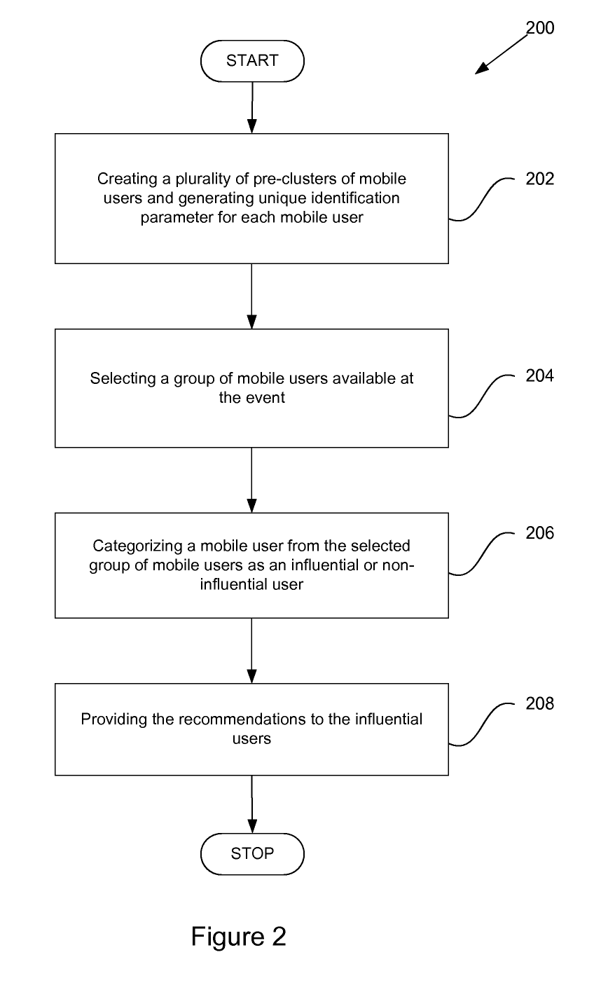

According to a first embodiment of the invention, a method 200 of providing one or more recommendations to one or more mobile users is illustrated in FIG. 2. The method comprises creating a plurality of pre-clusters of mobile users, comprising a plurality of mobile users in each pre-clusters, and generating a unique identification parameter for each mobile user in the respective pre-cluster, as disclosed in step 202. The unique identification parameter may comprise information regarding the preferences and priority of the mobile user. The unique identification parameter may be stored in the pre-clustered repository and monitored over a period of time to determine the priority and preferences of the mobile user. Step 204 discloses selecting a group of mobile users available at an event that may be interested in availing services being offered at the event. Step 206 discloses categorizing a mobile user from the selected group of mobile users as an influential or non-influential user, based on the identified specific behavior characteristic of the mobile user. The specific behavior characteristics may be the usage of pre-determined services by the mobile user and as the mobile user uses/subscribes for the pre-determined services, his priority of usage increases. According to an embodiment, a mobile user having a high priority is considered as an influential user with increased chances of receiving recommendations. Step 208 speaks of providing recommendations to each influential user among the plurality of mobile user available at the event.

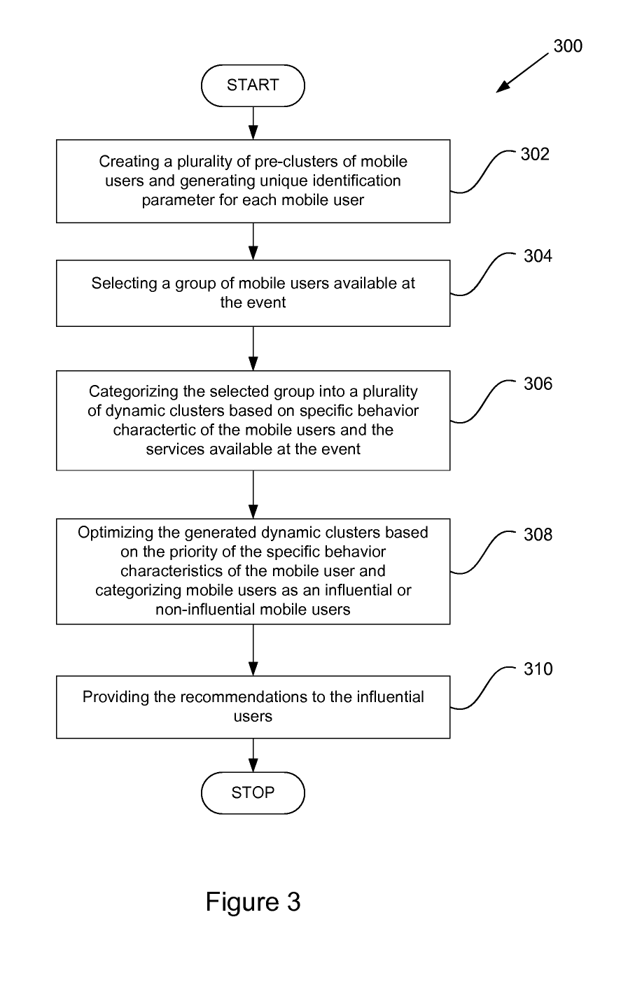

According to a second embodiment of the invention, an alternative method 300 of providing one or more recommendations to one or more mobile users is illustrated in FIG. 3. The method comprises creating a plurality of pre-clusters of mobile users and generating a unique identification parameter for each mobile user in the respective pre-cluster, as disclosed in step 302. Further, step 304 discloses selecting a group of mobile users available at an event. Step 306 discloses categorizing the selected mobile users into a plurality of dynamic clusters based on the specific behavior characteristic of the mobile user and services available at the event. Step 308 discloses optimizing the generated dynamic clusters based on the priority of the specific behavior characteristic of the mobile users and targeting one or more influential mobile users with specific recommendations, as disclosed in Step 310.

The above first and second embodiments of the invention are explained further below with the help of exemplary embodiments.

According to an aspect of the invention, each pre-cluster have a pre-defined group of mobile users. Pre-clusters may be e.g. a community or an office or a locality or a family, etc. According to an embodiment, the grouping of mobile users into pre-clusters may be based on a process of grouping mobile users within the community or a locality that are interested in receiving recommendations of services on their mobile communication devices. Further, the pre-clusters are updated on the basis of analyzing the likes and preferences of the mobile users, such as e.g. food preferences of the users, their behavior in social networks, ordering frequency of services, etc. The system may be configured to interact with different service providers to receive data relating to different services provided to the mobile users. The system may be further configured to update the pre-cluster upon receipt of data pertaining to each mobile user. This data may be considered for a pre-determined time to portray a clearer picture of the mobile users likes/dislikes, preference, usage, etc within the pre-cluster.

According to an exemplary embodiment, the system may be configured to communicate with CDRs (Charging Detail Record) to receive mobile user data such as e.g. calling number, called number, duration, cost etc. CDRs may be an external source of data for the pre-cluster which is managed by independent mobile service providers. The profile of the mobile user obtained from the CDRs helps in placing the mobile users in an appropriate pre-cluster that portrays their needs in the best possible way. According to an embodiment, advanced known data mining techniques are used to process the CDRs for obtaining the required information for pre-clusters.

According to another aspect of the invention, for each mobile user in each pre-cluster, a unique identification parameter, such as e.g. a unique number is generated. The unique identification parameter 500 comprise a static component 502 and a dynamic component 504 as illustrated in FIG. 5. The static component 502 comprise of a mobile user identification, here referred to as a Node ID, and a pre-cluster identification, here referred to as a cluster ID, and the type of cluster. The dynamic component 504 comprise of a priority identification of the mobile user for specific behavior characteristics in the respective pre-cluster. The mobile user identification is indicative of the position of the user within the pre-cluster and may be expressed e.g. as a roll number. The pre-cluster identification provides a unique number specific to the respective pre-cluster of the mobile user.

According to another embodiment of the invention, the unique identification parameter 500 is associated with each mobile user in the pre-cluster, such that the dynamic component 504 of the unique identification parameter 500 automatically updates the priority identification with respect to specific behavior characteristics of the mobile user. According to an embodiment of the invention, the specific behavior characteristics indicate the amount of usage of pre-defined services by the user.

According to another embodiment of the invention, as the mobile user uses a pre-defined service, the count of the priority identification is increased by a pre-determined number. If the count of the priority identification of the mobile user increases a pre-defined threshold, the chance of receiving mobile recommendations from the mobile recommendation system 100 increases.

According to another embodiment of the invention, the unique identification parameter 500 consists of a pre-defined number of digits, where the identification parameter acts as an Identity number or Roll Number that defines the mobile user.

Although the unique identification parameter illustrated in FIG. 5 is a 16-digit number it may have any other number of digits, as long as all data of the identification parameter can be set accordingly.

According to another aspect of the invention, selecting a group of mobile users available at an event includes identifying whether a mobile user is located at the event or not. This may be achieved by an interaction of the mobile user with a mobile service station providing network coverage at the event.

According to another embodiment of the invention, the mobile user may send a mobile location update to the mobile service station, indicating the presence of the mobile user at the event. Alternatively, the mobile service station may be configured to send a notification or an update to a plurality of mobile users. The mobile users replying when at the event may send a notification to the mobile service station indicating their presence at the event.

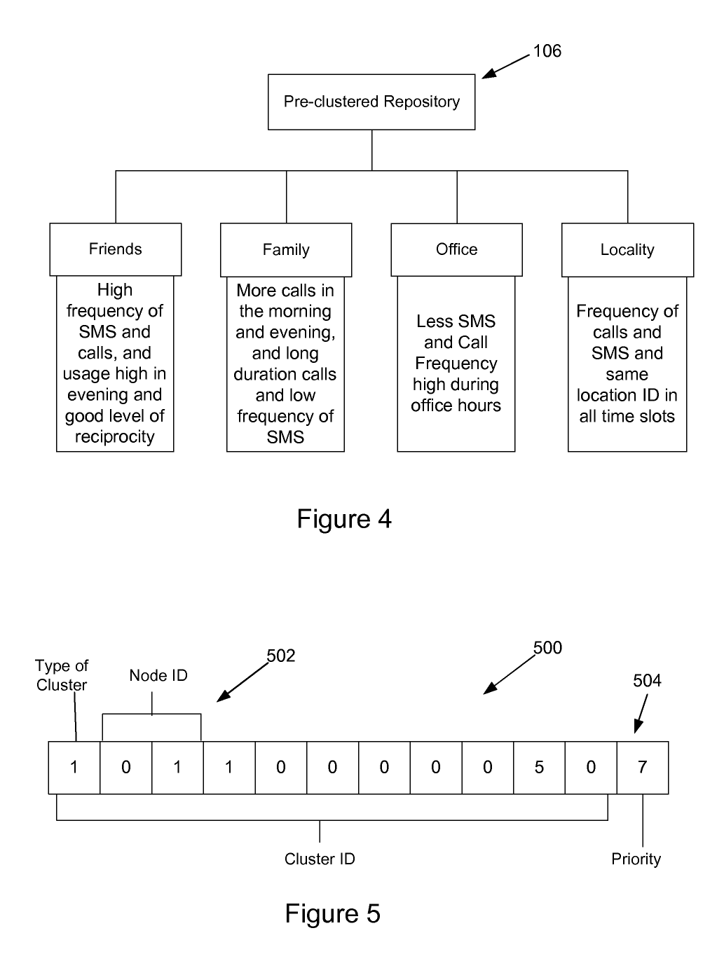

FIG. 4-8 illustrates an example showing a method of providing recommendations to a plurality of mobile users in accordance with an embodiment of the invention.

Referring now first to FIG. 4, this figure illustrates pre-clustering of mobile users based on properties, here represented by the four groups FAMILY, OFFICE, LOCALITY and FRIENDS. A pre-clustered repository 106 is mined on mobile user preference for the use of a home delivery service for their preferred food. The pre-clustered repository 106 may e.g. consider one month's data and output the preference of the respective mobile user, such as the food variety that is most ordered by the mobile user is assumed to be his preference. This may be repeated for a plurality of mobile users. The pre-cluster indicates the preference of each mobile user in relation to a particular home delivery service or a specific liking for a food category or an average amount spent on home delivery of food. This indication may be reflected in a priority ranking of the mobile user. For example, the higher the number of home delivery ordered, the higher the ranking of the mobile user within the pre-cluster. It is also imperative that the liking to a particular service provider of food or average amount spend on services can also be found out from the ranking of the mobile user. The ranking of mobile user within the pre-cluster may be indicated in their respective unique identification parameter 500.

Referring now to FIG. 5, this figure illustrates a unique identification parameter 500 associated with each mobile user in the pre-cluster. The unique identification parameter 500 is associated with each mobile user in the pre-cluster such that the unique identification parameter 500 automatically updates with respect to the usage of one or more pre-defined services by the mobile user such as e.g. home delivery of food. As the mobile user uses or subscribes for services, their priority automatically gets updated i.e. the dynamic component 504 of the unique identification parameter 500. The unique identification parameter 500 determines a specific pre-cluster to which the mobile user belongs such as 0/1=>Friends, 2/3=>Office, 4/5=>Family and 6/7=>Locality.

On the day of the event, one or more mobile users are selected on the basis of their presence at the event. According to a specific embodiment of the invention, the presence of the mobile users at the event may be determined by recognition in the system of an interaction between the mobile user and a mobile service station providing network coverage at the event.

Further, the group of selected mobile users is categorized into a plurality of dynamic clusters. Dynamic clustering is a specific type of clustering algorithm used for faster processing of information and configured to produce a better quality result.

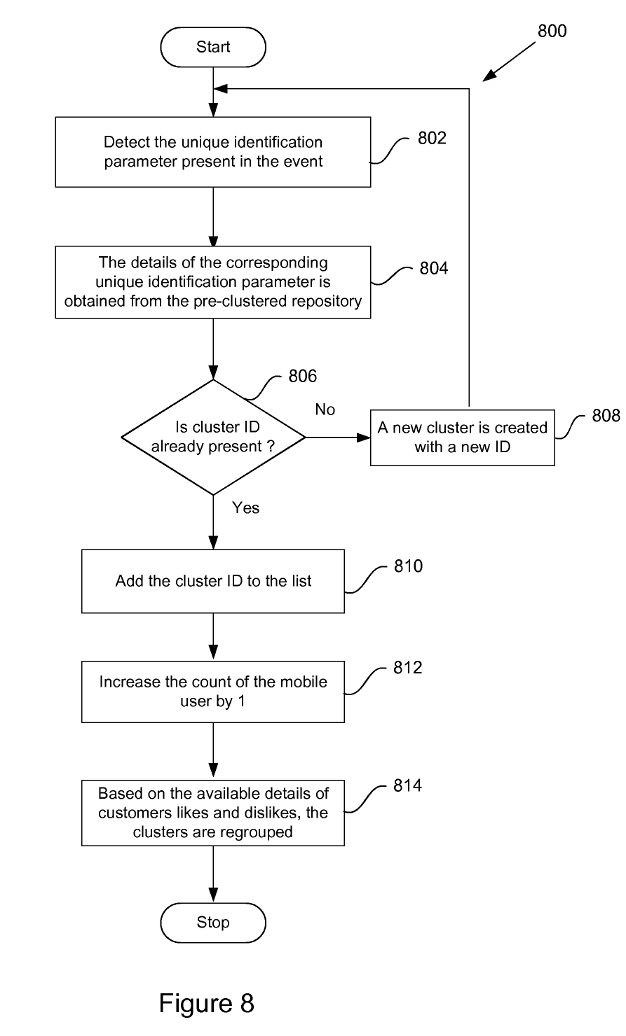

Further, FIG. 8 shows a method 800 of regrouping a pre-clusters into dynamic clusters on the basis of likes and dislikes of a mobile user. The unique identification parameter of the mobile user is detected if the mobile user is present at the event, as disclosed in step 802. Next, the details of the unique identification parameter are obtained from the pre-clustered repository, as disclosed in step 804. If the cluster ID is already present (step 806), add the cluster ID to a list of pre-clusters available at the event (step 810), otherwise create a new pre-cluster with a new ID (step 808). Next, increase a count of unique identification parameter of the mobile user by a pre-determined number, as disclosed in step 812. Further, based on the likes and dislikes of the selected mobile users, the pre-clusters are regrouped to form dynamic clusters, as disclosed in step 814.

The identified dynamic clusters are classified based on certain properties like interest in specific food items, etc. for example:—a mobile user may like pizza or continental food, etc. Therefore, based on the properties and the availability of the services at the event, the services to be recommended are finalized.

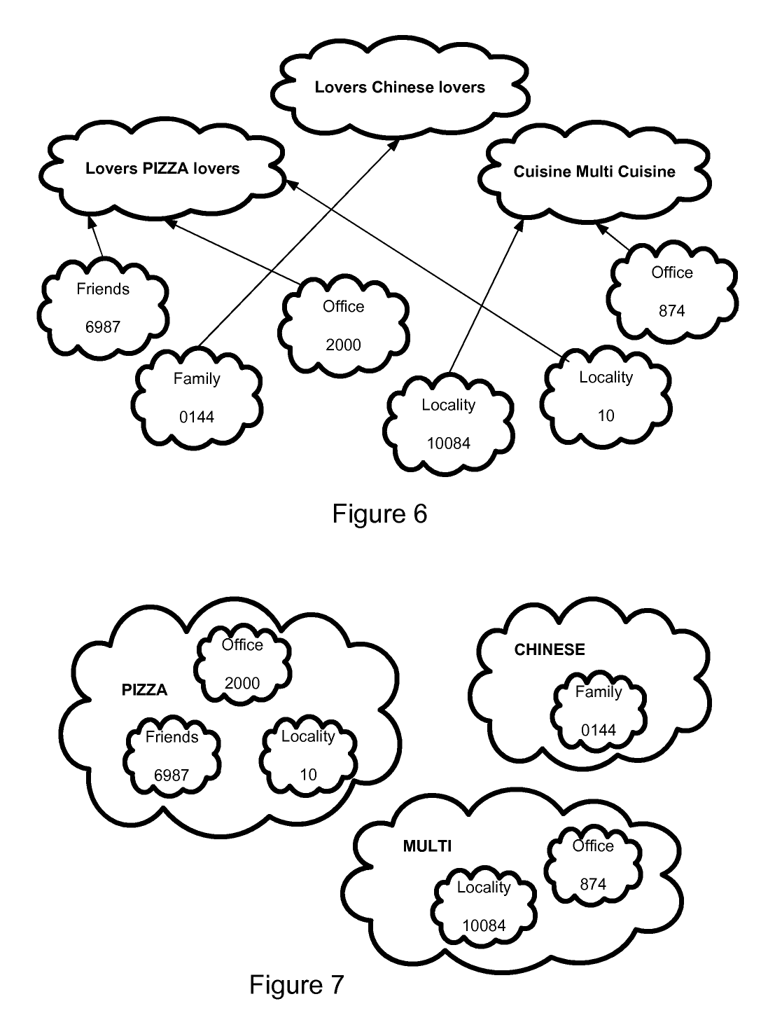

As and when the dynamic clusters are created, they are regrouped based on the recommendation. The regrouping is done based on the services offered by the service provider and the group interest towards selective food items as illustrated in FIGS. 6 and 7.

Further, instead of sending recommendations to all available mobile users at the event, the recommendations are sent only to a few selected mobile users who may avail these services. Further, the generated dynamic clusters are optimized based on the priority of the usage of similar food items by the mobile users. The selected mobile users are categorized into influential or non-influential users. The categorization is based on the past spending behavior of the selected mobile users on similar items. The influential mobile users are targeted with specific mobile recommendations.

According to another embodiment of the invention, the optimization technique may be Particle Swarm Optimization (PSO). PSO is used to identify and isolate the influential users in the group for targeted recommendations. PSO uses an algorithm to select and isolate the influential users that are to be targeted with specific mobile recommendations. The algorithm may be defined as follows:

1. For each g in c
2. If CIDg[0]==max then
ADD no.g to the list
end loop
3. IF list is empty then
maxpr= CIDg[0]
next g
for each g in c
if maxpr<CIDg[0] then
maxpr=CIDg[0]
select g
end if
end loop
4. assign alpha=g
ADD no.g to the list
5. IF countLIST=count/2+1 then
6. for max(g,neighbourg)
ADD no.neighbour to the list
end loop
end if
end IF

Terminology used in ALGORITHM:

| Algorithm Terms | Represents |
|---|---|
| g | customer in the cluster C |
| CID | cluster id - part of 16 digit number |
| Maxpr | understand the maximum priority rank |
| List | selective list of customers |
| Count | Number of customers in the cluster C |
| Alpha | Influential customer |
| countLIST | Number of customers in the list |

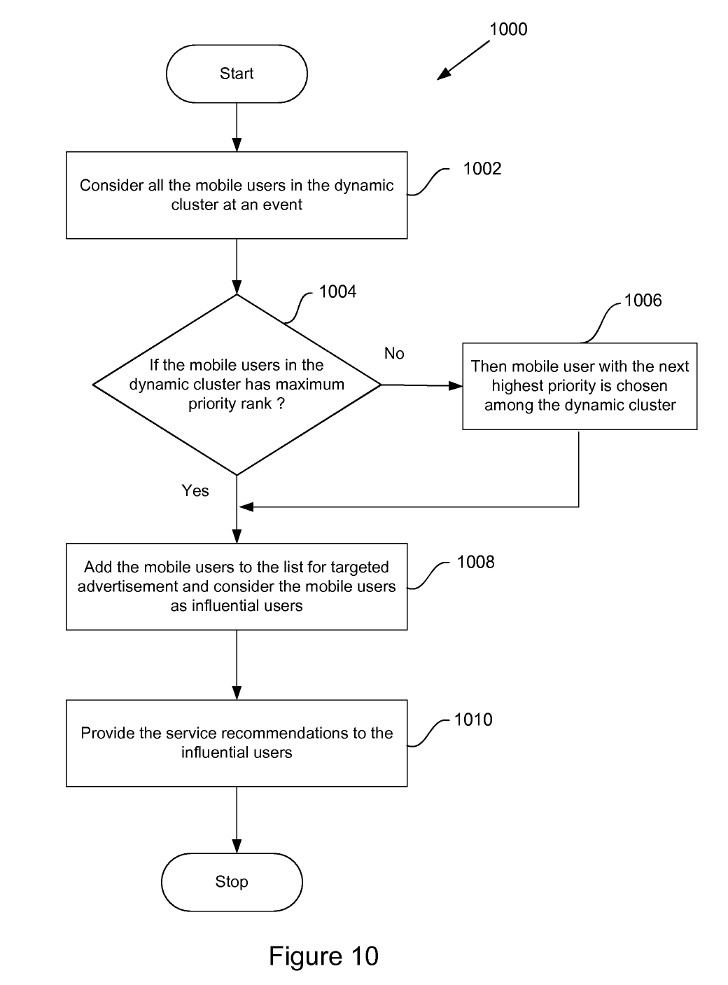

The above algorithm 1000 is illustrated with the help of a flow chart in FIG. 10 in accordance with an embodiment of the invention. All the mobile users in the dynamic clusters at the event are considered for providing recommendations as disclosed in step 1002. Further, the priority rank of the mobile user is determined. If it is determined in step 1004 that one or more mobile users have the maximum priority rank, these selected mobile users are considered as influential users, as disclosed in step 1008 and are targeted for mobile recommendations as disclosed in step 1010. If none of the mobile users at the event have the maximum priority rank, then the next highest priority rank is instead chosen (step 1006) and the mobile users which matches with this priority rank are selected for providing mobile recommendations, as disclosed in step 1010.

According to another embodiment of the invention, the mobile recommendation may be in the form of a SMS, MMS or a voice call. If a selected mobile user responds to the SMS or uses the service offered, then its priority rank will be increased by a pre-determined number. The response of the mobile user can be found using a feedback analysis or registering of the mobile identification number that availed the service.

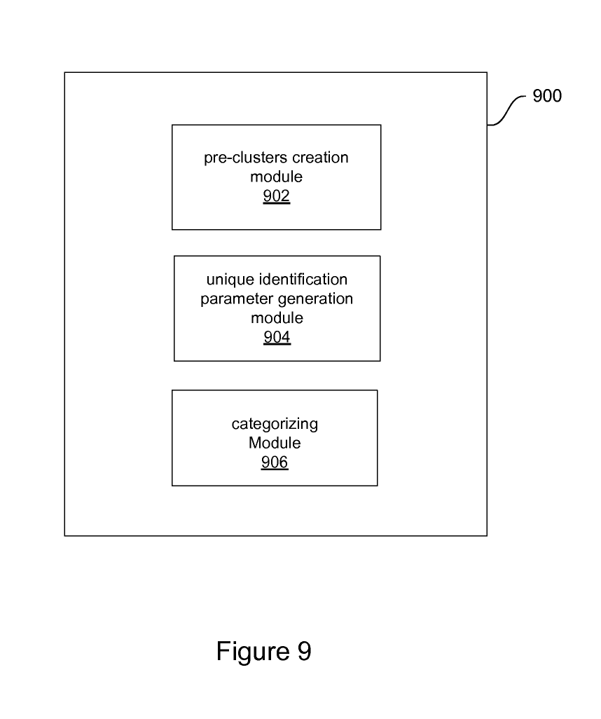

FIG. 9 illustrates a computer program product 900 in accordance with an embodiment of the invention. The computer program product 900 is in the form of a non-volatile memory, for instance an EEPROM (Electrically Erasable Programmable Read-Only Memory), a flash memory or a disk drive. The computer program product 900 comprises a computer readable code means (not shown) and a computer program, comprising code means which when run by or executed by the recommendation system 100 of FIG. 1 causes recommendations to be provided to a group of mobile users having a specific behavior characteristic among plurality of mobile users. The computer program product 900 of FIG. 9 comprise a pre-cluster generation module 902 for generating one or more pre-clusters, wherein each pre-cluster have a pre-defined group of mobile users and a unique identification parameter generation module 904 for generating a unique identification parameter for each mobile user, such that the unique identification parameter identify a priority of the specific behavior characteristic of the mobile user in one or more pre-clusters. The computer program product 900 may further comprise of a categorizing module 906 for selecting a group of mobile users as influential users among the pre-defined group of the mobile user based on the identified specific behavior characteristic of the mobile users. Alternatively, the modules may be arranged according to FIG. 1 or according to any other configuration, as long as it allows execution of any of the methods suggested above.

The disclosed system and methods have numerous advantages. For example, the time required to process and target mobile users is significantly reduced compared to other known systems. Due to processing of dynamic data, the memory used for the processing at the event is reduced. As the operator provides his services based on the likings of the users, the loyalty (satisfaction level) of the mobile user increases towards the service provider. The disclosed method may also increase the monetary benefits of the service provider, as deals can be struck between the service provider and the vendor to share profits. Accuracy of prediction is relatively high as compared to existing alternative models.

Moreover, the system and methods as described herein aim to provide and recommend services based on mobile user likes, dislikes and other characteristics. This is achieved by using various algorithms that analyze the behavior of the mobile user over a period with the available CDRs (Charging Detail Record) and other sources. The information thus analyzed and collected includes information, such as e.g. calling number, called number, duration, cost etc. CDRs may be an external source of data for the pre-clusters which is managed by independent mobile service providers. The disclosed system and methods implements advanced known data mining techniques to process CDRs for obtaining the required information for pre-clusters. According to an embodiment, the profile of the mobile users helps in placing them in an appropriate pre-cluster that portrays their needs in the best possible way. If the mobile users are gathering in a particular location for attending a specific event, a suitable model may be framed to recommend some products to the mobile users based on their interest and availability of a specific product offered at the event.

The foregoing description of implementations provides illustration and description, but is not intended to be exhaustive or to limit the invention to the precise form disclosed. Modifications and variations are possible in light of the above teachings, or may be acquired from practice of the invention.

Aspects of the invention may also be implemented in methods and/or a computer program product. Accordingly, the invention may be embodied in hardware and/or in hardware/software (including firmware, resident software, microcode, etc.). Furthermore, the invention may take the form of a computer program product on a computer-usable or computer-readable storage medium having computer-usable or computer-readable program code embodied in the medium for use by or in connection with an instruction execution system. The actual software code or specialized control hardware used to implement embodiments described herein is not limiting the invention. Thus, the operation and behavior of the aspects are described without reference to the specific software code, it is understood that one would be able to design software and control hardware to implement the aspects based on the description herein.

Furthermore, certain portions of the invention may be implemented as “logic” that performs one or more functions. This logic may include hardware, such as an application specific integrated circuit or field programmable gate array or a combination of hardware and software.

While specific language has been used to describe the invention, any limitations arising on account of the same are not intended. As would be apparent to a person in the art, various working modifications may be made to the method in order to implement the inventive concept as taught herein.

1. A method of providing a unique identification parameter to each of a plurality of mobile users to identify specific behavior characteristic of the mobile users, comprising the steps of:
creating a plurality of pre-clusters, wherein each pre-cluster have a pre-defined group of the mobile users;
generating a unique identification parameter for each mobile user, the unique identification parameter comprising a static component and a dynamic component, the static component comprising a mobile user identification and a pre-cluster identification and the dynamic component comprising a priority identification of the mobile user for specific behavior characteristics in the respective pre-cluster; and
associating each unique identification parameter with the respective mobile user, such that the dynamic component of the unique identification parameter automatically updates the priority identification with respect to the specific behavior characteristics of the respective mobile user.

2. The method as claimed in claim 1, wherein grouping of the mobile users into pre-clusters is based on at least one pre-determined parameter.

3. The method as claimed in claim 1, wherein the specific behavior characteristics is indicating the usage of at least one pre-defined service by the mobile user.

4. The method as claimed in claim 1, wherein the priority identification is updated by increasing it by a pre-determined number with respect to the specific behavior characteristics of the mobile user.

5. A method of providing one or more recommendations to a group of mobile users present at an event and having specific behavior characteristics among a plurality of mobile users, comprising the steps of:
creating a plurality of pre-clusters, wherein each pre-cluster have a pre-defined group of mobile users and generating a unique identification parameter for each mobile user for identifying a priority of specific behavior characteristics of the mobile user in the respective pre-cluster;
selecting a group of mobile users available at the event;
categorizing a mobile user from the selected group of mobile users as an influential or non-influential user based on the identified specific behavior characteristics of the respective mobile user; and
providing the one or more recommendations to each influential user among the plurality of mobile users available at the event.

6. The method as claimed in claim 5, wherein selecting a group of mobile users available at the event includes identifying whether a mobile user is located at the event or not, the identification being based on an interaction of the mobile user with a mobile service station providing network coverage at the event.

7. The method as claimed in claim 6, wherein identifying whether a mobile user is located at the event or not further includes performing a mobile location update of the mobile user.

8. The method as claimed in claim 7, wherein identifying whether a mobile user is located at the event or not further includes:
receiving at the mobile service station a notification from a mobile user present at the event.

9. The method as claimed in claim 6, wherein identifying whether a mobile user is located at the event or not further includes:
sending a notification from the mobile service station to the mobile user; and
receiving a notification from the mobile users present at the event.

10. The method as claimed in claim 5, further comprising categorizing the selected mobile users into a plurality of dynamic clusters based on the specific behavior characteristics of each mobile user and services available to the selected mobile users at the event.

11. The method as claimed in claim 5, further comprising optimizing the generated dynamic clusters based on the priority of the specific behavior characteristics of the mobile users and targeting one or more influential mobile users with specific recommendations.

12. The method as claimed in claim 5, wherein providing the recommendations to the influential user by way of a SMS, MMS or a voice call to a mobile communication device of the mobile users.

13. A mobile recommendation system for providing one or more recommendations to a group of mobile users having specific behavior characteristics among a plurality of mobile users, the mobile recommendation system comprising:
a pre-clustered repository configured to store pre-cluster data of the group of mobile users;
a processor capable of controlling:
a mobile identification generation module configured to create a plurality of pre-clusters of mobile users with regard to the pre-cluster data stored in the pre-clustered repository and to generate a unique identification parameter for each mobile user for identifying a priority of the specific behavior characteristics of the respective mobile user in the respective pre-cluster; and
a categorizing module configured to:
identify the group of mobile users with respect to the specific behavior characteristics of each mobile user, and to
categorize one or more mobile users as influential users among the selected group of mobile users based on the unique identification parameter, and
identifying at least one recommendation for the selected influential users; and
a mobile interface configured to communicate one or more recommendations to each influential mobile user.

14. The mobile recommendation system as claimed in claim 13, further comprising a service provider interface configured to communicate with at least one service provider to receive information about services being offered to the selected group of mobile users.

15. The mobile recommendation system as claimed in claim 13, wherein the specific behavior characteristics of a respective mobile user is indicating the usage of at least one pre-defined service by the mobile user.

16. The mobile recommendation system as claimed in claim 13, wherein the pre-cluster repository is further configured to store the unique identification parameter of each respective mobile user.

17. The mobile recommendation system as claimed in claim 13, wherein the categorizing module is further configured to select a group of mobile users located at an event based on an interaction of the mobile users with a mobile service station providing network coverage at the event.

18. The mobile recommendation system as claimed in claim 17, wherein the categorizing module is further configured to categorize a plurality of mobile users from the selected group into a plurality of dynamic clusters with respect to specific behavior characteristics of each of the selected mobile users and services available to the selected group of mobile users at the event.

19. The mobile recommendation system as claimed in claim 18, wherein the categorizing module is further configured to optimize the generated dynamic clusters based on the priority of the specific behavior characteristics of the selected mobile users and to target the mobile users of at least one optimized cluster with the recommendations thereon.

20. The mobile recommendation system as claimed in claim 13, further comprising a clustered data repository for storing the dynamic clusters of mobile users.

21. A system comprising a unique identification parameter for identifying a specific behavior characteristic of a mobile user among a plurality of mobile users, the unique identification parameter comprising:
a static component comprising a mobile user identification and a pre-cluster identification, wherein each pre-cluster have a pre-defined group of mobile users; and
a dynamic component comprising a priority identification of the mobile user wherein the dynamic component automatically updates the priority identification with respect to the specific behavior characteristics of the respective mobile user in the pre-cluster.

22. The system of claim 21, wherein the unique identification parameter consists of a pre-defined number of digits.

23. The system of claim 21, wherein the dynamic component increases a count of the priority identification by a pre-defined number with respect to the usage of one or more pre-defined services by the mobile user.

24. A computer program product comprising a non-transitory computer readable medium storing a computer program for providing recommendations to a group of mobile users having specific behavior characteristics among a plurality of mobile users, the computer program comprising code which when run on a mobile recommendation system, causes the mobile recommendation system to:
create a plurality of pre-clusters, wherein each pre-cluster have a pre-defined group of mobile users and generate a unique identification parameter for each mobile user for identifying a priority of the specific behavior characteristics of the respective mobile user in the respective pre-cluster;
select a group of mobile users available at the event;
categorize a mobile user belonging to the selected group of mobile users as an influential or a non-influential user based on the identified specific behavior characteristic of the mobile user; and
provide at least one recommendation to each influential user among the plurality of mobile users available at the event.

25. (canceled)
